(19) United States
(12) Patent Application Publication
(10) Pub. No.: US 2003/0115598 A1
(43) Pub. Date: Jun. 19, 2003

(54) System and method for interactively producing a web-based multimedia presentation

(76) Inventor: William E. Pantoja, Folsom, CA (US)

Correspondence Address: PATRICK J S INOUYE P S, 810 3RD AVENUE, SUITE 258, SEATTLE, WA, 98104, US

(21) Appl. No.: 10/260,005

(22) Filed: Mar. 21, 2002

Related U.S. Application Data
(60) Provisional application No. 60/278,530, filed on Mar. 23, 2001.

(51) Int. Cl. H04N 5/445; H04N 7/173

(52) U.S. Cl. 725/40; 725/112

(57) ABSTRACT

A system and method for interactively producing a Web-based multimedia presentation is described. A multimedia template is selected and includes a layout having at least one video window specifying a location to playback video content and one or more content windows. Each content window specifies a location to display static content. Video content is integrated into the template and includes content formatted for dynamic playback in the video window. One or more events are associated into the template. Each event includes content formatted for static display in one such content window at temporally defined points during the dynamic playback of the video content.

### COPYRIGHT NOTICE

A portion of the disclosure of this patent document contains material which is subject to copyright protection. The copyright owner has no objection to the facsimile reproduction by anyone of the patent document or the patent disclosure as appearing in the Patent and Trademark Office patent file or records, but otherwise reserves all copyright rights whatsoever.

### CROSS-REFERENCE TO RELATED APPLICATIONS

This patent application is a conversion of U.S. provisional patent application Serial No. 60/278,530, filed Mar. 23, 2001, pending, the priority date of which is claimed and the disclosure of which is incorporated by reference.

### FIELD OF THE INVENTION

The present invention relates in general to multimedia presentation production and, in particular, to a system and method for interactively producing a Web-based multimedia presentation.

### BACKGROUND OF THE INVENTION

Multimedia is a form of communication integrating different types of media, such as audio and still imagery. To be effective, the individual media elements should be complementary to and integrated with each other to help communicate a cohesive message, rather than presenting a disconnected collection of individual ideas.

In the computer arts, multimedia refers to an arrangement of several forms of electronic media representing conventional media, such as written text, analog video and audio, and moving and still imagery in digital form. As used herein, the term “multimedia” will henceforth refer only to those computer-implemented arrangements of electronic media.

Multimedia presents an effective platform for providing education, training, advertising, entertainment, and other forms of information dissemination, particularly when implemented in an interactive fashion. Interactive multimedia that incorporates feedback helps to increase the reception and understanding of the underlying message by involving the user and increasing interest levels through active participation. Interactive multimedia is preferably presented in an integrated environment which includes a user interface and related components that together provide a common look and feel. The integrated environment can be a stand-alone application, a set of applications, or an entire operating system.

In particular, multimedia usage is often embedded as content into Web pages. A “Web” page, shorthand for Worldwide Web page, is an interpretable script written in a tag-delimited page description language, such as the Hypertext Markup Language (HTML) or the Extensible Markup Language (XML). Individual Web pages are downloaded from Web servers and interpreted by Web browsers executing on individual clients.

Web pages can be used both in stand-alone and in distributed computing environments, including intranetworks, internetworks, such as the Internet, and in other settings, such as television, movie theaters, and in any similar format that includes some form of visual display, preferably with interactive capabilities. Web pages, HTML, XML, and related concepts are described generally in R. Orfali, “Client/Server Survival Guide,” Chs. 26-29, John Wiley & Sons, Inc. (3d ed. 1999), the disclosure of which is incorporated herein by reference.

Web pages can contain video content, such as provided through streaming video. Video content, including audio and video tracks, is divided into a set of small data packets which are sent as a data stream to Web browsers for viewing. The video content is available for viewing as the packets are received, thereby avoiding the potentially significant delay which would otherwise be incurred for a full download. The alternative to streaming video is live video. As used herein, “video” refers to moving imagery which preferably includes an audio soundtrack.

Web-based multimedia content integrates different types of information into a single presentation. Producing Web pages that incorporate multimedia content elements consequently requires coordination between the production and end-user environments. Each data type, such as video content, imagery, text, HTML, scripts, and Uniform Resource Locators (URLs) requires a different type of client-side display capability. For example, video content requires a streaming or live media video player while imagery and text require static display space. Embedded HTML scripts must be interpreted prior to display. Finally, URLs must be logically linked to the external resource to which the URL refers. As a result, the production environment must structure each Web-based multimedia presentation to enable proper viewing by a client system capable of presenting the different types of content embedded within each Web page.

In particular, providing integrated multimedia containing video and static content requires client-side sequencing and synchronization during playback. In the prior art, streaming video content, such as video content compliant with the Microsoft streaming media specification, includes index markers embedded into the video content stream that signal a client Web browser to execute an action, such as displaying an image or outputting text. The index markers provide an integrated means to sequence and synchronize static content with video content playback. However, video content streams are susceptible to interruption during transmission and can cause a mis-sequencing or de-synchronization of the static content display. In a worse case, the static content may not be displayed at all.

Therefore, there is a need for an approach to an integrated multimedia presentation production environment providing video playback that is sequenced and synchronized to static content display independent of data format.

There is a further need for an approach to providing an integrated multimedia presentation environment that can create an environment-independent timing script and image preloader to provide responsive integrated content playback and display.

### SUMMARY OF THE INVENTION

The present invention provides a system and method for producing and playing interactive multimedia content. During production, video content is associated with a video window defined in a layout of a user-selectable template. The video content is timed and individual events associated with different types of static content are incorporated into the presentation at user-selectable timing points during video playback. The video content and events are stored in a hierarchically structured database. During playback, the video content and events are retrieved from the database and an XML timing script is generated from the retrieved events. Preferably, any embedded images are preloaded into a local buffer. The video is then played and the static content displayed at the selected timing points independent of interruptions in the video stream.

An embodiment provides a system and a method for interactively producing a Web-based multimedia presentation. A multimedia template is selected and includes a layout having at least one video window specifying a location to playback video content and one or more content windows. Each content window specifies a location to display static content. Video content is integrated into the template and includes content formatted for dynamic playback in the video window. One or more events are associated into the template. Each event includes content formatted for static display in one such content window at temporally defined points during the dynamic playback of the video content.

A further embodiment provides a system and method for providing interactive playback of a multimedia presentation. A temporal script of a multimedia presentation is built. The temporal script includes video content including content formatted for dynamic playback and one or more events associated with the video content at temporally defined points. Each event includes content formatted for static display. The video content is played in at least one video window in a layout specifying a location to playback the video content. Each event is displayed at the associated temporally defined point in one or more content windows in a layout with each content window specifying a location to display static content.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a functional block diagram showing a distributed networking environment.

FIG. 2 is a block diagram showing a system for interactively producing a Web-based multimedia presentation in accordance with the present invention.

FIG. 3 is a process flow diagram showing the operations performed to produce a multimedia presentation using the system of FIG. 2.

FIG. 4 is a block diagram showing the functional software modules of the server used in the system of FIG. 2.

FIG. 5 is a tree diagram showing the hierarchical structuring of the sites, categories and presentations stored in the database of FIG. 4.

FIG. 6 is a block diagram showing the functional software modules of the production client used in the system of FIG. 2.

FIG. 7 is a screen shot showing, by way of example, a template used by the production client of FIG. 6.

FIG. 8 is a block diagram showing the functional software modules of the playback client used in the system of FIG. 2.

FIG. 9 is a screen shot showing, by way of example, an integrated presentation space performing a video content playback exported by the system of FIG. 2.

FIG. 10 is a flow diagram showing a method for interactively producing a Web-based multimedia presentation in accordance with the present invention.

FIG. 11 is a flow diagram showing the process performed by the production server of FIG. 4.

FIG. 12 is a flow diagram showing the process performed by the production client of FIG. 6.

FIG. 13 is a flow diagram showing the process performed by the playback client of FIG. 8.

FIG. 14 is a flow diagram showing the routine for retrieving events for use in the routine of FIG. 13.

FIG. 15 is a flow diagram showing the routine for playing back video content for use in the routine of FIG. 13.

### DETAILED DESCRIPTION

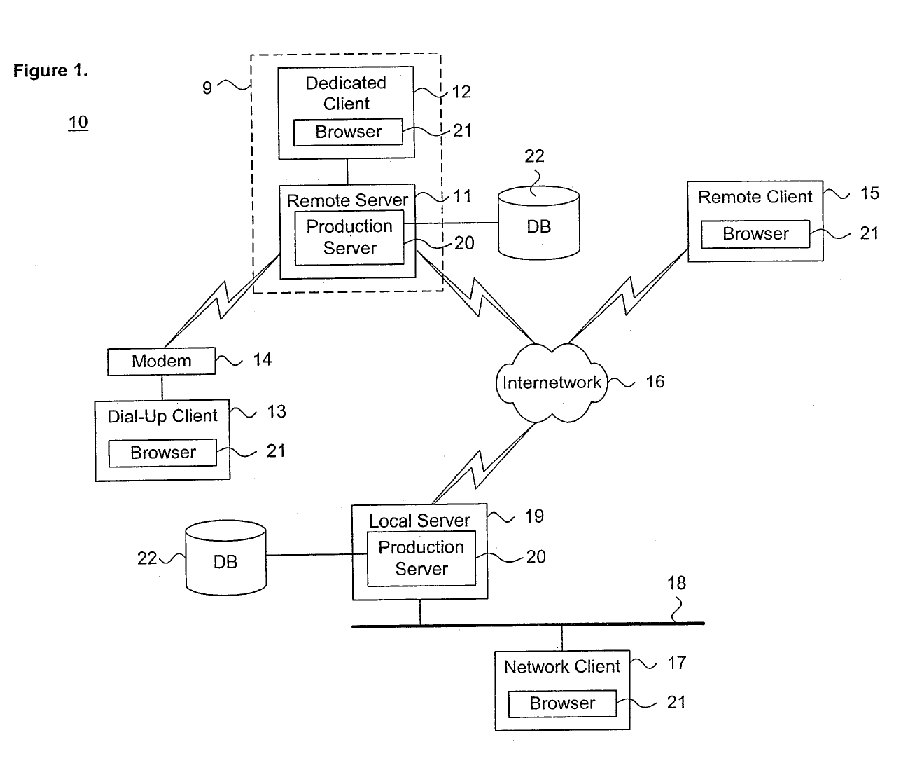

FIG. 1 is a functional block diagram showing a distributed networking environment 10. The environment 10 includes a plurality of individual clients, including a dedicated client 9, dial-up client 13, remote client 15, and network client 17. Each of the clients executes a Web browser 21 that provides ubiquitous access to Web-based multimedia, preferably structured in accordance with the Hypertext Markup Language (HTML).

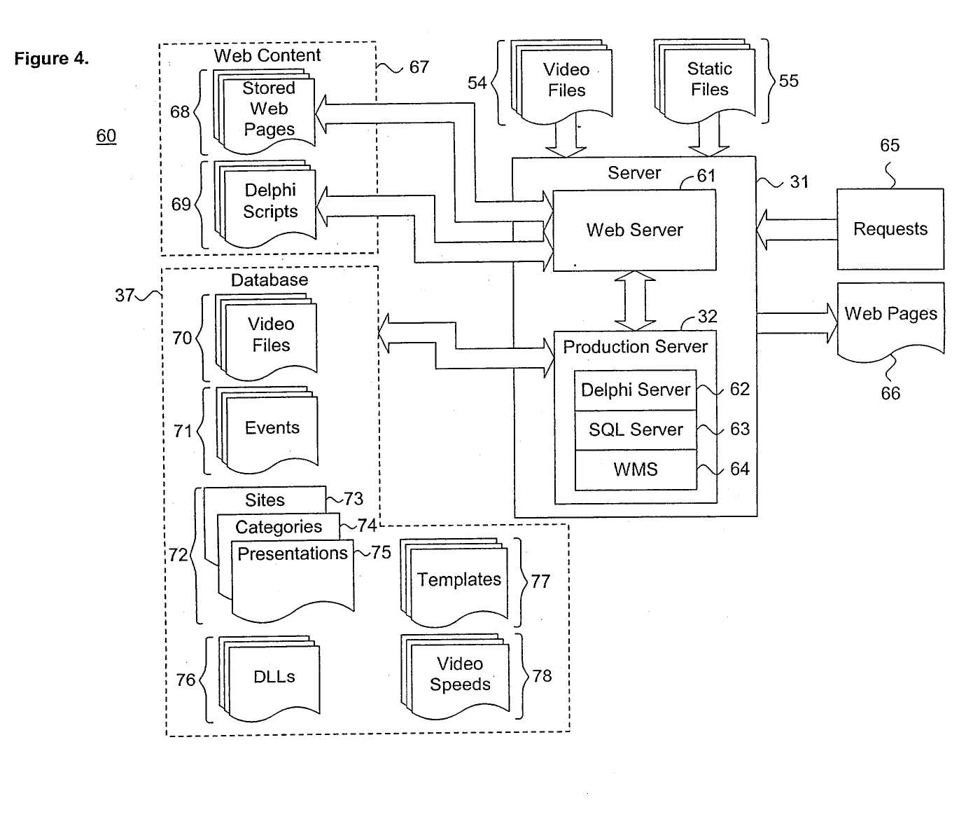

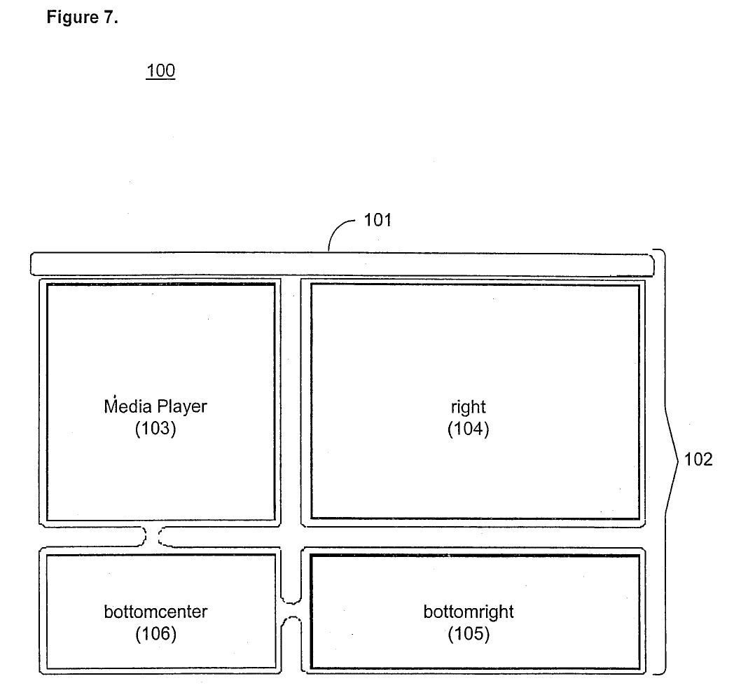

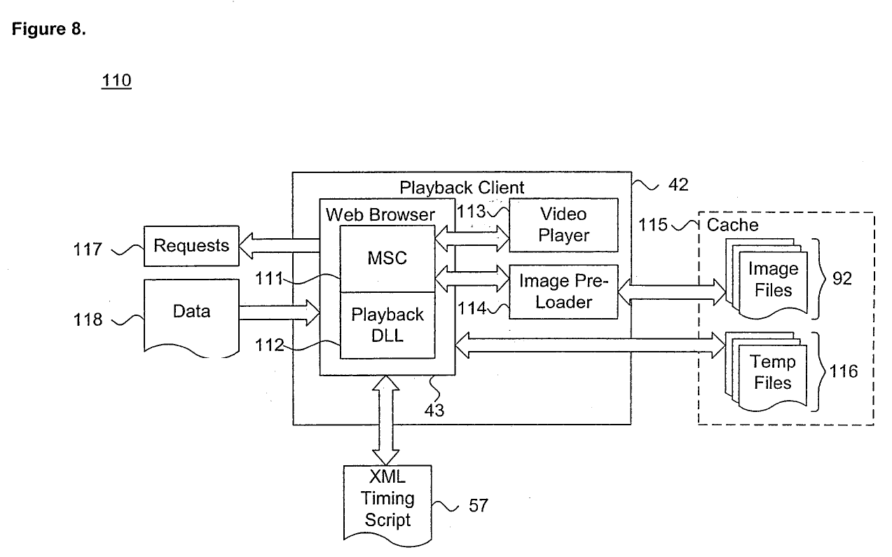

The individual clients provide interactive playback of video content produced by a production server 20 executed by either a remote server 11 or local server 19, as further described below with reference to FIGS. 4 and 7. The interactive playback is provided through the Web browsers 21, as further described below with reference to FIG. 8. The Web browsers 21 provide a ubiquitous multimedia presentation environment. In the described embodiment, each client and server operating within the distributed computing environment 10 implements a Transmission Control Protocol/Internet Protocol (TCP/IP) network stack, although other preferably packet-based network protocols could equally apply.

Within the distributed computing environment 10, the remote server 11 and the local server 19 provide conventional network services, such as file access, remote system access, and content provision, to various clients. Typically, these network services are available through standardized TCP/IP protocols, such as the File Transport Protocol (FTP), Telnet, and Hypertext Transport Protocol (HTTP). In particular, the remote server 11 and local server 19 include Worldwide Web (“Web”) server (not shown) serving Web content in the form of Web pages maintained in a preferably hierarchically structured database 22.

Individual clients are communicatively interfaced to the remote server 11 and local server 19. By way of illustration, several types of clients are interfaced to the remote server 11 via a plurality of interfacing means and having various network bandwidth capabilities. For instance, a dedicated client 12 is interfaced via a dedicated, direct connection to the remote server 11, such as via a serial interface. Typically, serial interfaces, depending upon type, offer network bandwidth in the range of 75 baud to 115.2 Kbaud. As well, the dedicated client 12 could be logically interfaced as part of an integrated system 9 including both the remote server 11 and dedicated client 12 operating on the same physical machine. Also, a dial-up client 13 is interfaced via a modem 14. Typically, modems, depending upon type, offer network bandwidth in the range of 300 baud to 56.6 Kbaud. Similarly, a remote client 15 is interfaced via an internetwork 16, such as the Internet. Typically, internetwork connections, depending upon type, offer network bandwidth up to 1.544 Mbps on a T1 carrier or 45 Mbps on a T3 carrier. In addition, a network client 17 is configured to operate within an intranetwork 18 locally serviced by the local server 19 and is interfaced to the remote server 11 via the internetwork 16. Typically, intranetwork connections, depending upon type, internally offer network bandwidth up to 100 Mbps. Other network topologies and configurations of computational resources, including various combinations of intranetworks and internetworks, are possible.

In a further embodiment, the Web browsers 21 operate as part of an integrated system 9 interfaced to a digital, preferably interactive, display system, such as used in information kiosks, movie theaters, and similar technologies in which digital multimedia is utilized.

The individual computer systems included in the distributed computing environment 10 are general purpose, programmed digital computing devices consisting of a central processing unit (CPU), random access memory (RAM), non-volatile secondary storage, such as a hard drive or CD ROM drive, network interfaces, and peripheral devices, including user interfacing means, such as a keyboard and display. Program code, including software programs, and data are loaded into the RAM for execution and processing by the CPU and results are generated for display, output, transmittal, or storage.

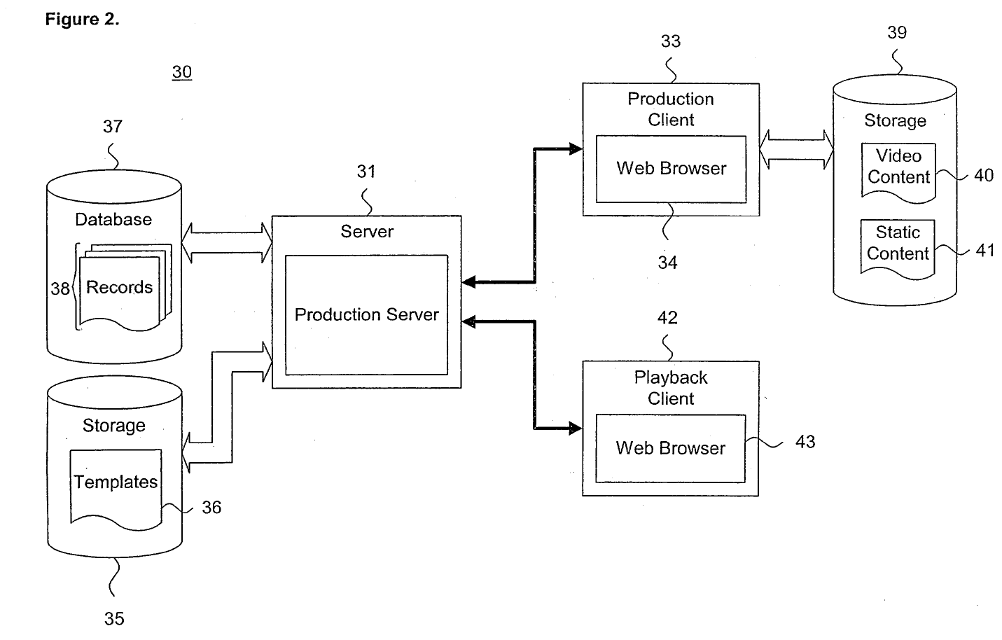

FIG. 2 is a block diagram showing a system 30 for interactively producing a multimedia presentation in accordance with the present invention. The system 30 consists of a server 31 interfaced to a production client 33 and playback client 42. The server 31 executes a production server 32, as further described below with reference to FIG. 4. The production server receives requests from both the production client 33 and playback client 42 to respectively produce and playback an interactive multimedia presentation.

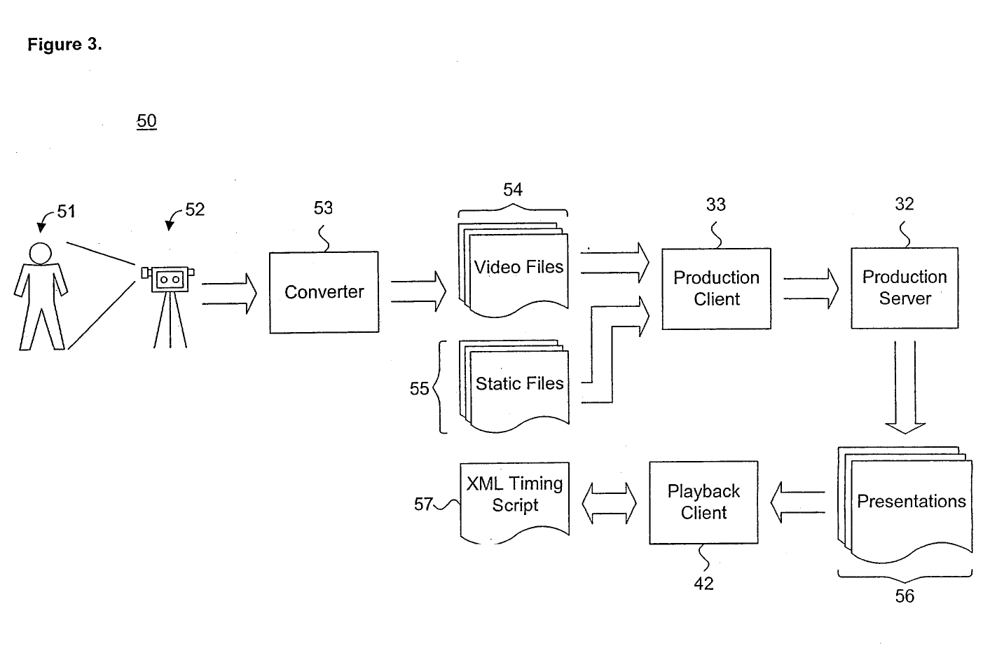

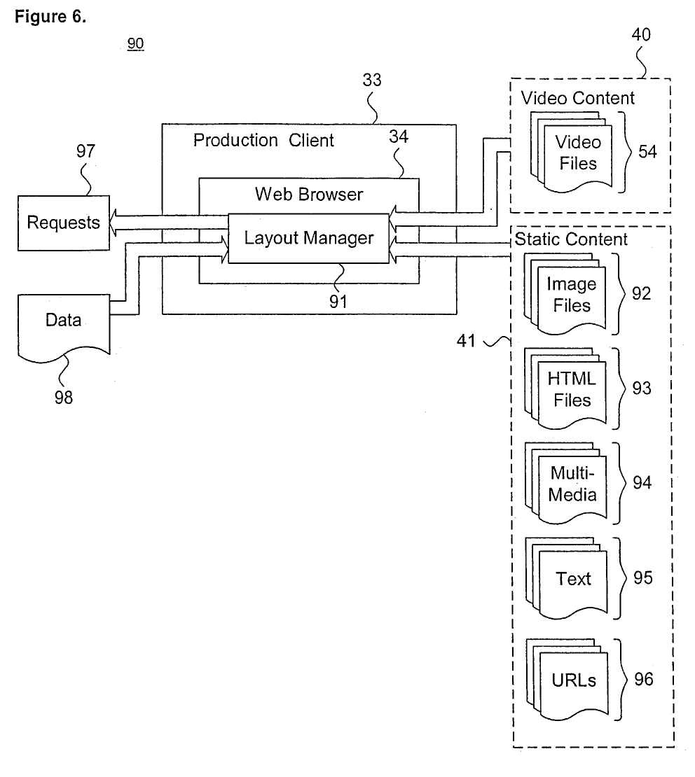

During presentation production, the production server 32 executes a Web-based production application for viewing via a Web browser 34 executed by the production client 33. The production client 33 maintains video content 40 and static content 41 in attached storage device 39. The video content 40 and static content 41 are integrated by the production client 33 into an interactive multimedia presentation, as further described below with reference to FIG. 6. The production client 33 interfaces to the production server 32 to access templates 36 maintained in attached storage device 35. The production server 32 stores the associations of the video content 40 and static content 41 into indexed database records 38 maintained in a database 37, preferably a structured SQL database, such as licensed by Oracle Corporation, Redwood Shores, Calif. By way of example, a database schema used in the described embodiment is provided in the Appendix, although other database schemas, arrangements, and organizations are possible, as would be recognized by one skilled in the art. The production server 32 produces interactive multimedia presentations by integrating video and static content into presentations stored in a hierarchical organizational structure, as further described below with reference to FIG. 3.

The playback client 42 provides an integrated presentation environment exported within the Web browser 43, as further described below with reference to FIG. 8. The integrated presentation environment includes a multi-screen clinic (not shown) that includes presentation panels within a user-specified layout for viewing video and static content keyed to indices incorporated into the video track, such as described in commonly-assigned U.S. patent application Ser. No. 09/560,017, filed Apr. 27, 2000, pending, the disclosure of which is incorporated by reference. Alternatively, the static content can preferably be keyed to temporally-defined timing points within an environment-independent script, such as written in the Extensible Markup Language (XML), that sequences and synchronizes each static content item for display at a specific time during video playback.

FIG. 3 is a process flow diagram showing the operations 50 performed to produce a multimedia presentation using the system 30 of FIG. 2. A production begins with the raw recordation (operation 52) of a subject 51 into an analog or digital video format. If applicable, the raw analog video is converted by a converter 53 into digital video files 54. The production client 33 (shown in FIG. 2) logically combines the digital files 54 with static content files 55 via the production server 32. In the described embodiment, by way of example, the static content files 55 can contain digital images; multimedia content, including video, and sound files; HTML scripts; text; and URLs.

The production server 32 maintains the presentations 56 as logical collections of video and static content associated with a user-selected template. The presentations 56 can be accessed by a playback client 42 for presentation using, for instance, a multi-screen clinic or other form of integrated multimedia presentation environment. Upon retrieving a presentation 56 for playback, the playback client 42 generates a timing script 57, preferably in XML, that associates temporally-defined timing points within the video content with the display of associated static content.

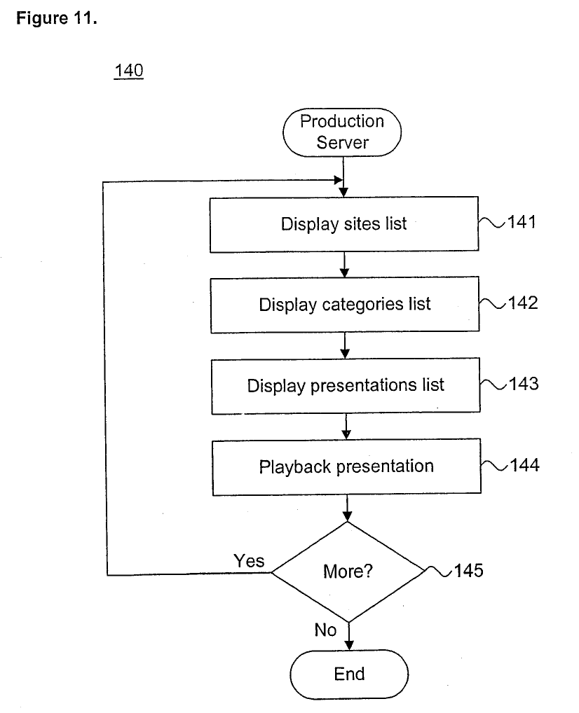

FIG. 4 is a block diagram showing the functional software modules of the server 31 used in the system of FIG. 2. Each module is a computer program written as source code in a conventional programming language, such as the Delphi programming language, and is presented for execution by the CPU of the server 31 as object or byte code, as is known in the art. The various implementations of the source code and object and byte codes can be held on a computer-readable storage medium or embodied on a transmission medium in a carrier wave. The production server 32 operates in accordance with a sequence of process steps, as further described below beginning with reference to FIG. 11.

The server 31 consists of two functional components: Web server 61 and production server 32. Basically, the Web server 20 serves Web content 67, principally consisting of stored Web pages 68 written as interpretable, tag-delimited scripts, in response to requests 65 received from clients. In the described embodiment, the Web pages 68 are written in HTML, although any similar Web page description language, such as XML, could be used.

The production server 32 is logically defined as a Web browser-based application accessed via a client system. Each of the individual screens within the production server 32 is generated by the Web server 61 as interpreted Web pages 68. The production server 32 consists of three sub-components: Delphi server 62, SQL server 63, and Windows Media Server (WMS) 64. The Delphi server 62 executes Delphi scripts 69 embedded within the stored Web pages 68. The Web server 61 passes the scripts to the Delphi server 62 for execution. The Delphi scripts 69 specify how the requests 65 are processed and how the resultant Web pages 66 of the production server 32 are generated.

The SQL server 63 stores into the database 37 video files 70, events 71, dynamic linkable libraries (DLLs) 76, templates 77, video speeds 78, and sites 73, categories 74 and presentations 75 in a hierarchical structure 72. The database 37 is populated as the production server 32 integrates video files 54 and static files 55 containing static content into the multimedia templates 77. Each template 77 includes a layout of one or more video windows and one or more content windows. Each video window specifies a location to playback the video content and each of the content windows specifies a location to display the static content. The video content is integrated into the template by forming an association between the video content and the selected templates 77. Once integrated, each video file 54 is copied into the database 37. Similarly, static content is associated with a user-selected template as events 71 which are stored in the database 37. The events 71, as further described below with reference to the Appendix, store the parameters specific to the type of stored static content. Once integrated, each static file 55 is copied into the database 37.

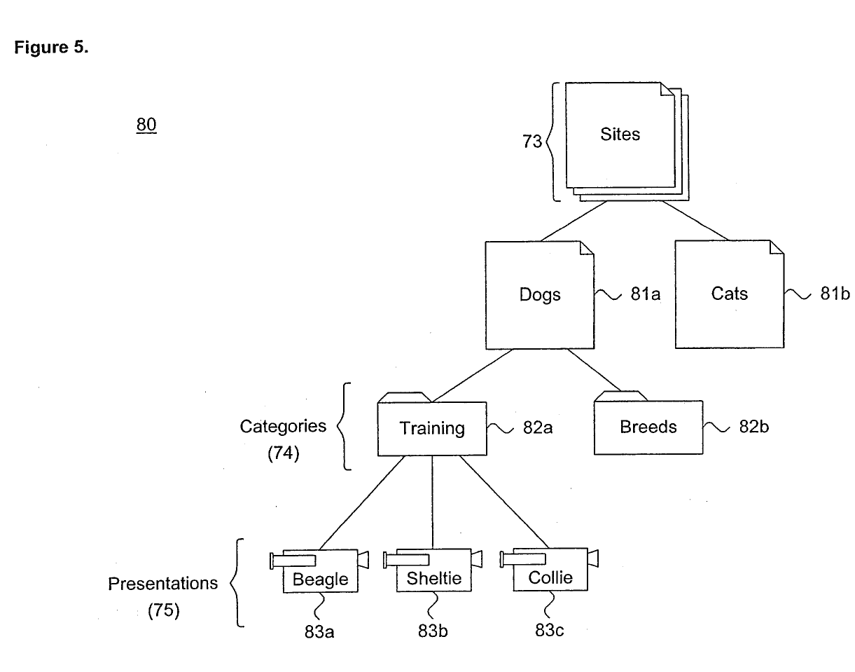

The produced multimedia presentations are maintained in a hierarchical structure 72 within the database, consisting of sites 73, categories 74, and presentations 75, as further described below with reference to FIG. 5. The hierarchical structure 72 allows the presentations 75 to be organized into functionally related folders that can be navigated through a user interface.

The windows media server 64 is used during the playback of a stored video file 70. The windows media server 64 sends the playback as a stream of video content using a predesignated video speed 78 specified for the selected video file 70. During playback of a presentation, the playback client 42 executes a plug-in module retrieved from the database 37 as a Dynamic Linkable Library (DLL) 76. The DLL includes a codec to playback the streamed video content and display the static content in the template 77.

FIG. 5 is a tree diagram 80 showing the hierarchical structuring of the sites, categories and presentations stored in the database 37 of FIG. 4. Presentations 75 are grouped into individual categories 74 by individual site 73. The hierarchical structuring allows the presentations 75 produced by the production server 31 (shown in FIG. 2) to be organized into a user-friendly format that facilitates ease of use.

By way of example, the sites 73 could include individual sites for dogs 81a and cats 81b. In turn, the dogs site 81a could include two categories 74: training 82a and breeds 82b. The training category 82a could then include a number of presentations 75 for beagles 83a, shelties 83b, and collies 83c. Other forms of hierarchical structuring and categorizations and groupings of presentations, categories, and sites are feasible, as would be recognized by one skilled in the art.

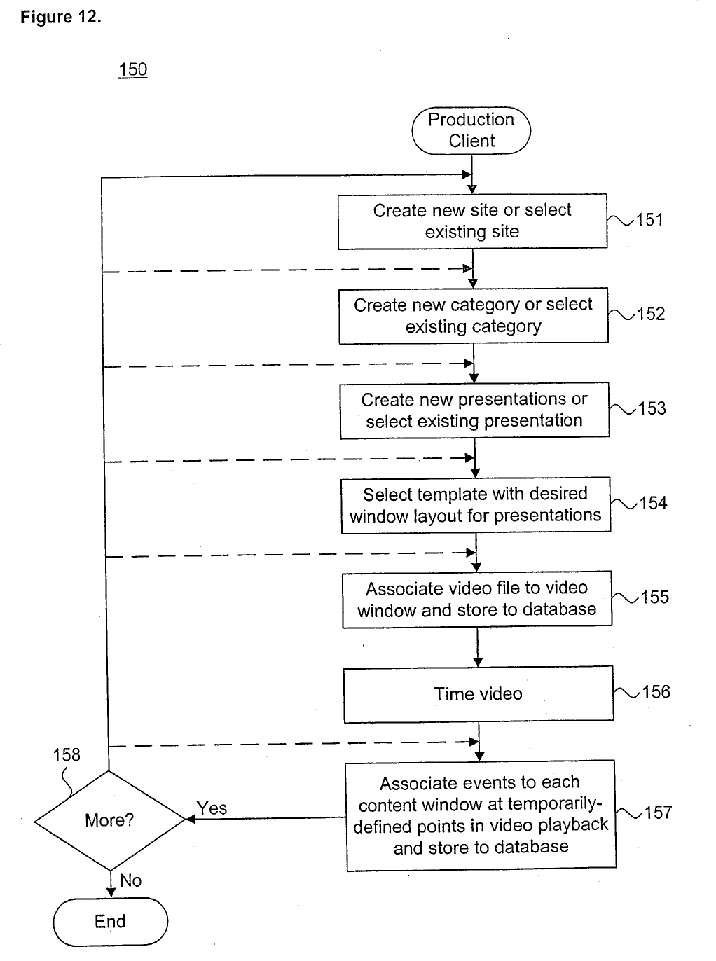

FIG. 6 is a block diagram showing the functional software modules 90 of the production client 33 used in the system 30 of FIG. 2. Each module is a computer program written as source code in a conventional programming language, such as the Delphi programming language, and is presented for execution by the CPU of the production client 33 as object or byte code, as is known in the art. The various implementations of the source code and object and byte code can be held on a computer-readable storage medium or embodied on a transmission medium carrier wave. The production client 33 operates in accordance with a sequence of process steps, as further described below beginning with reference to FIG. 12.

The production client 33 consists of two embedded functional components: Web browser 34 and layout manager 91, executed by the Web browser 34. The Web browser 34 is an ordinary Web browser application for viewing Web pages (not shown), as is known in the art. The Web browser 34 sends requests 97 to the production server 32 which returns back data 98 for presentation by the layout manager 91. The Web pages are received from the production server 32 (shown in FIG. 2) to logically define the operations performed to produce an interactive multimedia presentation.

The production client 33 facilitates the production of interactive multimedia presentations by integrating video content 40 and static content 41 into layouts defined in templates 77 (shown in FIG. 4). The video content 40 consists of individual video files 54 generated from raw analog or digital video sources through conventional conversion means, as is known in the art. The static content 41 can include image files 92, such as formatted in JPEG, GIF, and similar file formats. Static content 41 can also include HTML script files 93, multimedia files 94, text 95, and URLs 96.

Each of these various forms of static content 41 are associated with a content window in the layout by the layout manager 91. Each static content 41 is associated with an event 71 stored with a copy of the static content in the database 37. Each event 71 identifies properties particular to the type of static content 41 specified. Each event 71 includes a unique identifier and temporally-defined timing point specifying the point at which the static content is to be displayed during playback of the associated video content 40.

Each of the various types of static content 41 must be associated with a content window capable of displaying that type of static content. For example, an image file 92 can only be displayed in a content window defined to display images. Likewise, an HTML script file 93 can only be displayed in a content window defined for interpreting and displaying the results of an HTML script. Similarly, additional video windows can be specified within the layout to display or play back multimedia files 94 in sequence with the primary video window. Lastly, URLs 96 can only be displayed in content windows within a layout capable of supporting a hyperlink to further content retrieved over a network.

FIG. 7 is a screen shot 100 showing, by way of example, a template 101 used by the production client 33 of FIG. 6. The template 101 defines a plurality of individual windows 102 in which video and static content are played and displayed. For example, a media player window 103 provides the video window for video content playback. The remaining right window 104, bottom right window 105, and bottom center window 106 provide static content windows for displaying images, interpreted HTML scripts, multimedia content, text, or URLs. In the described embodiment, additional non-display type events are also available to represent NULL and PAUSE operations. Other various configurations, arrangements and combinations of video and static content window layouts are possible, as would be recognized by one skilled in the art.

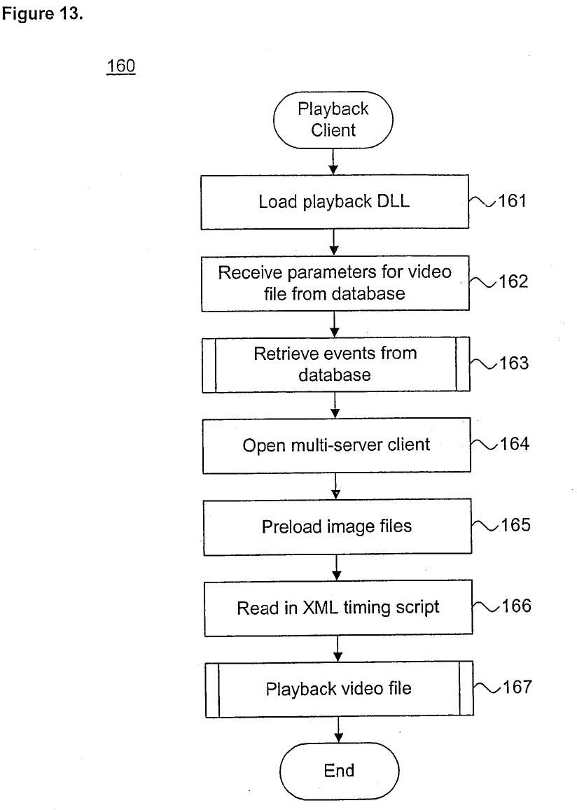

FIG. 8 is a block diagram showing the functional software modules of the playback client 42 used in the system of FIG. 2. Each module is a computer program written as source code in a conventional programming language, such as the Delphi programming language, and is presented for execution by the CPU of the client 32 as object or byte code, as is known in the art. The various implementations of the source code and object and byte codes can be held on a computer-readable storage medium or embodied on a transmission medium in a carrier wave. The playback client 42 operates in accordance with a sequence of process steps, as further described below beginning with reference to FIG. 13.

The playback client 42 consists of five functional components: Web browser 29, multi-screen clinic (MSC) 111, playback DLL 112, video player 113, and image pre-loader 114. The browser 43 is an ordinary Web browser application for viewing Web pages, as is known in the art. Web content, including Web pages downloaded from the Web server 61 (shown in FIG. 4) is staged as temporary files 116 maintained in a local cache 115. In the described embodiment, the Internet Explorer Web browser, licensed by Microsoft Corporation, Redmond, Wash., is used, although any equivalent Web browser, such as the Navigator Web browser, licensed by Netscape Corporation, Mountain View, Calif., could be used.

The multi-screen clinic (MSC) 111 is a modular framework defining an integrated presentation space within the Web browser 43. In the described embodiment, the multi-screen clinic 111 is logically defined via a series of Web pages received from the Web server 61 in response to a video selection. The multi-screen clinic 111 provides an extensible architecture which allows integrated functionality between presentation panels for interactively viewing multimedia segments, such as video, still imagery, advertisements, and information. These multimedia segments can also be integrated with electronic commerce, as would be recognized by one skilled in the art.

The video player 113 plays the requested video in a video presentation panel (not shown) logically defined within the multi-screen clinic 111. Video playback does not start until substantially all of the still image files for the requested video file have been downloaded into the local cache 115 by the image pre-loader 113. In the described embodiment, the video presentation panel is generated by the Windows Media Player product, licensed by Microsoft Corporation, Redmond, Wash. Alternatively, the Real Media Player, licensed by Real Networks, Inc., Seattle, Wash., or any similar video playback application, could also be utilized.

The image pre-loader 114 downloads substantially all of the image files constituting a slideshow. Each requested video includes a slideshow of still imagery content for augmenting lower resolution video content. The slideshow is downloaded prior to video playback with the individual still image files stored as temporary image files 92 staged in the local cache 115. The image pre-loader 113 enables the use of a lower network bandwidth connection between the playback client 42 and the production server 32. Rather than attempting to simultaneously receive both video and still imagery, the image pre-loader serializes the data into separate downloads, thereby enabling the video player 113 to utilize maximum available network bandwidth. An image pre-loader suitable for use in the present invention is described in the commonly-assigned, related U.S. patent application Ser. No. 09/560,684, filed Apr. 27, 2000, pending, the disclosure of which is incorporated herein by reference. Upon completion of the download, the image pre-loader 113 signals the Windows Media Server 64 (shown in FIG. 4) to begin sending the video to the video player 113.

The playback client 42 sends requests 117 for presentations and information to the production server 32 (shown in FIG. 2) and receives back data 118 for processing and display by the Web browser 43. A playback DLL 112 is executed as a plug-in module to the Web browser 43. The playback DLL 112 generates an XML timing script 57 as each event 71 is retrieved from the database 37 (shown in FIG. 4). The XML timing script 57 identifies the timing point during the playback at which the associated static content is displayed. The playback DLL 112 reads the XML timing script 57 during the video playback by the multi-screen clinic 111 to trigger the displaying of the associated static content. The playback DLL 112 tracks the actual playback time of the video content, thereby avoiding reliance for sequencing and synchronization on a continuous video stream. Interruptions in the stream will not interfere with the displaying of static content.

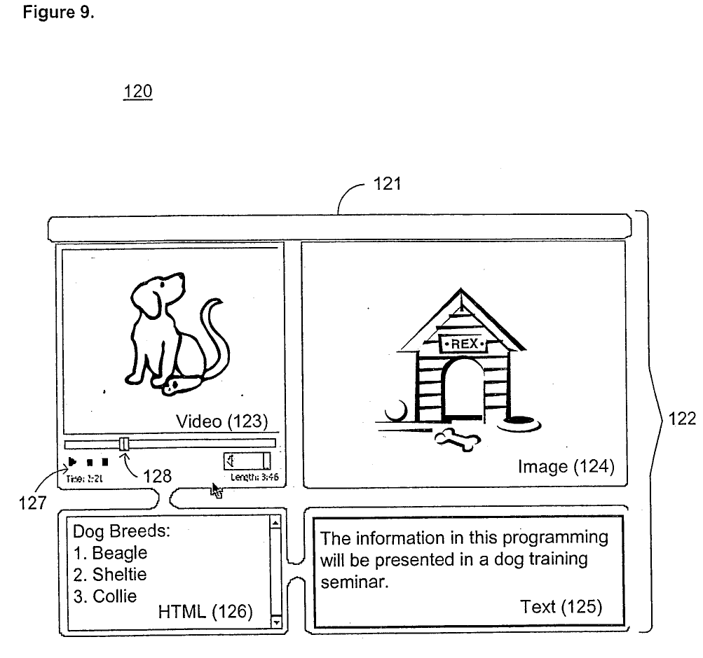

FIG. 9 is a screenshot 120 showing, by way of example, an integrated presentation space 121 performing a video content playback exported by the system 30 of FIG. 2. The integrated presentation space 121 includes a plurality of windows 122 corresponding to the layout of the template 101 (shown in FIG. 7). The integrated presentation space 121 is logically defined by the multi-screen clinic 111 (shown in FIG. 8) to define a logical video window 123, image display window 124, text display window 125, and HTML script window 126. A set of dynamically generated user controls 127 is provided with the video playback window 123 to allow flexible user control over the presentation. The playback controls 127 are integrated with the playback DLL 112 to allow seamless sequenced and synchronized display of static content based on an actual playback timing point within the video content identified by the slider indicator 128. The size of the video window 123 will vary depending upon the video speed 78 (shown in FIG. 4) used. Lower video speeds result in smaller video windows. The use of a relative time scale, as represented by the slider 128, allows immediate transitions between static content without reliance upon video-embedded index markers. Playback of video content and displaying of the associated static content is thereby enhanced and seamless.

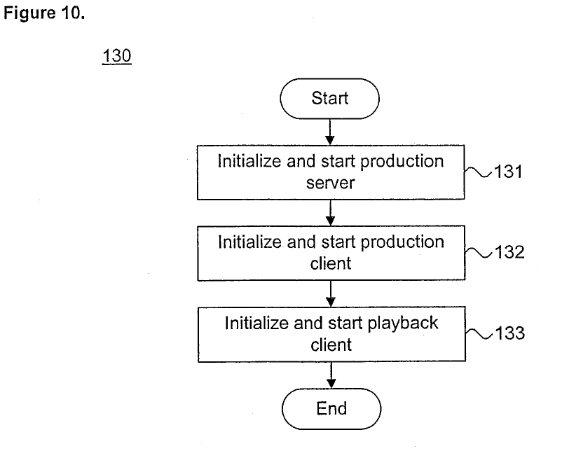

FIG. 10 is a flow diagram showing a method 130 for interactively using a multimedia presentation 56 (shown in FIG. 3) in accordance with the present invention. The individual components, including the production server 32, production client 33, and playback client 42, execute independently. Each of the components must be initialized and started (blocks 131-133) prior to interactive media presentation production. Upon respective initialization and starting, each components proceeds independently, as further described below with reference to FIGS. 12-14.

FIG. 11 is a flow diagram showing the process 140 performed by the production server 32 of FIG. 4. When accessed by a client, the production server 32 enables a user to peruse the hierarchical structuring of the database 37 (shown in FIG. 4) and to play a stored presentation 56 for review and editing.

Thus, the sites list 73 is displayed (block 141). The categories list 74 is displayed (block 142). The presentations list 75 is displayed (block 143). Finally, the presentation is played back and, in a further embodiment, edited (block 144). Additional operations can be repeated (block 145), after which the routine ends.

FIG. 12 is a flow diagram showing the process 150 performed by the production client 42 of FIG. 6. The operations executed by the production client 33 are logically defined through a Web-based application and are executed as transactions committed against the database 37 (shown in FIG. 20).

Thus, a new site 73 is created or an existing site 73 is selected (block 151). A new category 74 is created or an existing category 74 is selected (block 152). A new presentation 75 is created or an existing presentation 75 is selected (block 153). A template 77 is selected with the desired window layout for a presentation (block 154). A video file 54 is associated with the video window and stored to the database 37 (block 155). The selected video is then timed (block 156). Events 71 are associated with each content window at temporarily-defined points in the video playback and stored to the database 37 (block 157). The operations performed on the sites 73, categories 74, presentations 75, video files 70, and events 71 (blocks 151-155 and 157, respectively) can be repeated (block 158) as required. The routine then ends.

FIG. 13 is a flow diagram showing the process 160 performed by the playback 42 of FIG. 8. The playback client 42 is logically defined by a Web browser 43 (shown in FIG. 8) which executes a multi-screen clinic 111 and playback DLL 112.

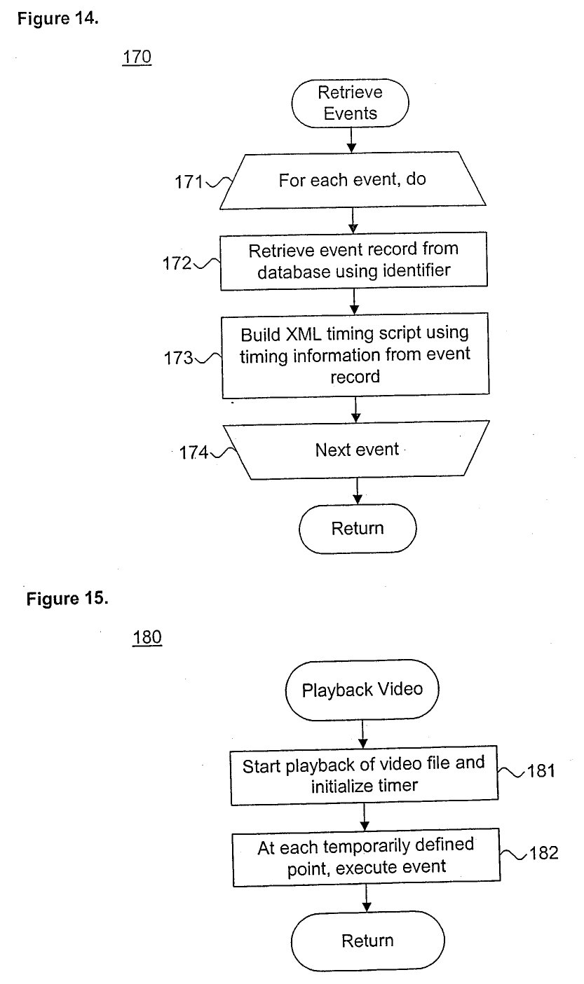

Thus, the playback DLL 112 is loaded (block 161) from the production server 32 (shown in FIG. 4). The parameters for the video files 70 are retrieved from the database 37 (block 162). Next, the events 71 are retrieved from the database 237 (block 163), as further described below with reference to FIG. 14. The multi-screen clinic 111 is opened (block 164) and the image files 92 (shown in FIG. 8) are preloaded by the image preloader 114 (block 165). The XML timing script 57 is read by the playback DLL 112 (block 166). Finally, the video file 70 is played back (block 167), as further described below with reference to FIG. 15. The routine then ends.

FIG. 14 is a flow diagram showing the routine 170 for retrieving events 71 (shown in FIG. 4) for use in the routine of FIG. 13. The purpose of this routine is to iteratively retrieve each of the events 71 associated with the video file 70 and to create the XML timing script 57 for use during playback.

Each of the associated events 71 (shown in FIG. 4) are iteratively processed (blocks 171-174) as follows. Each event record 38 (shown in FIG. 2) is retrieved from the database 37 using a database identifier (block 172). The XML timing script 57 is then built using the timing information stored with the event record 38 (block 173). Processing continues with the next event (block 174), after which the routine ends.

FIG. 15 is a flow diagram showing the routine 180 for playing back video content for use in the routine of FIG. 13. The purpose of this routine is to play back selected video content Web sequenced and synchronized with static content display.

Playback of the video file 70 (shown in FIG. 4) is started and an internal timer is initialized by the playback DLL 112 (shown in FIG. 8) (block 181). The timer used by the playback DLL 112 allows the correct sequencing and synchronization of the associated static content independent of interruptions in the playback stream from the production server 32. At each temporally-defined point in the playback, the event 71 is executed (block 182) by displaying the associated static content as defined by the data type. The routine then returns.

While the invention has been particularly shown and described as referenced to the embodiments thereof, those skilled in the art will understand that the foregoing and other changes in form and detail may be made therein without departing from the spirit and scope of the invention.

[image]

[image]

[image]

What is claimed is:

1. A system for interactively producing a Web-based multimedia presentation, comprising:
a stored multimedia template comprising a layout including at least one video window specifying a location to playback video content and one or more content windows each specifying a location to display static content; and
a production server integrating video content into the template and comprising content formatted for dynamic playback in the video window, and associating one or more events into the template and each event comprising content formatted for static display in one such content window at temporally defined points during the dynamic playback of the video content.

2. A system according to claim 1, further comprising:
a layout manager creating a new layout by specifying at least one video window specifying the location to playback the video content and at least one content window specifying the location to display the static content.

3. A system according to claim 1, further comprising:
a database storing at least one of the video content and the events as records.

4. A system according to claim 3, further comprising:
a hierarchy defined in the database structuring the stored records.

5. A system according to claim 4, wherein the hierarchy comprises sites, categories, and presentations.

6. A system according to claim 4, wherein the database is SQL-compatible.

7. A system according to claim 1, further comprising:
a record specifying the video content in a connection speed-specific format.

8. A system according to claim 1, further comprising:
a script written in a tag delimited page description language associating events with the video content.

9. A system according to claim 1, wherein the tag delimited page description language comprise one of HTML and XML.

10. A system according to claim 1, wherein each event comprises at least one of an HTML script, image, multimedia content, text, and URL.

11. A system according to claim 1, wherein the video content comprises at least one of a video, soundtrack, and combination thereof.

12. A method for interactively producing a Web-based multimedia presentation, comprising:
selecting a multimedia template comprising a layout including at least one video window specifying a location to playback video content and one or more content windows each specifying a location to display static content;
integrating video content into the template and comprising content formatted for dynamic playback in the video window; and
associating one or more events into the template and each event comprising content formatted for static display in one such content window at temporally defined points during the dynamic playback of the video content.

13. A method according to claim 12, further comprising:
creating a new layout by specifying at least one video window specifying the location to playback the video content and at least one content window specifying the location to display the static content.

14. A method according to claim 12, further comprising:
storing at least one of the video content and the events as records in a database.

15. A method according to claim 14, further comprising:
structuring the stored records as a hierarchy.

16. A method according to claim 15, wherein the hierarchy comprises sites, categories, and presentations.

17. A method according to claim 15, wherein the database is SQL-compatible.

18. A method according to claim 12, further comprising:
specifying the video content in a connection speed-specific format.

19. A method according to claim 12, further comprising:
associating events with the video content using a script written in a tag delimited page description language.

20. A method according to claim 12, wherein the tag delimited page description language comprise one of HTML and XML.

21. A method according to claim 12, wherein each event comprises at least one of an HTML script, image, multimedia content, text, and URL.

22. A method according to claim 12, wherein the video content comprises at least one of a video, soundtrack, and combination thereof.

23. A computer-readable storage medium holding code for performing the method according to claim 12.

24. A system for providing interactive playback of a multimedia presentation, comprising:
a playback module building a temporal script of a multimedia presentation that comprises video content comprising content formatted for dynamic playback and one or more events associated with the video content at temporally defined points and comprising content formatted for static display;
a video player playing the video content in at least one video window in a layout specifying a location to playback the video content; and
a multi-screen clinic module displaying each event at the associated temporally defined point in one or more content windows in a layout with each content window specifying a location to display static content.

25. A system according to claim 24, further comprising:
a client application executing the multi-screen clinic module to present the layout.

26. A system according to claim 25, further comprising:
user controls exported from the client application providing interactive playback controls of the video content.

27. A system according to claim 26, wherein the client application comprises at least one of an ASP and a JavaScript application.

28. A system according to claim 25, further comprising:
a timer maintained during the playing of the video content and tracking each temporally defined point against the timer.

29. A system according to claim 24, further comprising:
a database retrieving the video content and the events as records stored.

30. A system according to claim 29, further comprising:
a hierarchy defined in the database structuring the stored records.

31. A system according to claim 30, wherein the hierarchy comprises sites, categories, and presentations.

32. A system according to claim 29, wherein the database is SQL-compatible.

33. A system according to claim 24, further comprising:
a script writer writing the temporal script in a tag delimited page description language.

34. A system according to claim 33, wherein the tag delimited page description language comprise one of HTML and XML.

35. A system according to claim 24, further comprising:
an image pre-loader preloading the events prior to the playing of the video content.

36. A system according to claim 24, wherein each event comprises at least one of an HTML script, image, multimedia content, text, and URL.

37. A system according to claim 24, wherein the video content comprises at least one of a video, soundtrack, and combination thereof.

38. A method for providing interactive playback of a multimedia presentation, comprising:
building a temporal script of a multimedia presentation that comprises video content comprising content formatted for dynamic playback and one or more events associated with the video content at temporally defined points and comprising content formatted for static display;
playing the video content in at least one video window in a layout specifying a location to playback the video content; and
displaying each event at the associated temporally defined point in one or more content windows in a layout with each content window specifying a location to display static content.

39. A method according to claim 38, further comprising:
executing a client application to present the layout.

40. A method according to claim 39, further comprising:
exporting user controls from the client application providing interactive playback controls of the video content.

41. A method according to claim 40, wherein the client application comprises at least one of an ASP and a JavaScript application.

42. A method according to claim 39, further comprising:
maintaining a timer during the playing of the video content; and
tracking each temporally defined point against the timer.

43. A method according to claim 38, further comprising:
retrieving the video content and the events as records stored in a database.

44. A method according to claim 43, further comprising:
structuring the stored records as a hierarchy.

45. A method according to claim 44, wherein the hierarchy comprises sites, categories, and presentations.

46. A method according to claim 43, wherein the database is SQL-compatible.

47. A method according to claim 38, further comprising:
writing the temporal script in a tag delimited page description language.

48. A method according to claim 47, wherein the tag delimited page description language comprise one of HTML and XML.

49. A method according to claim 38, further comprising:
preloading the events prior to the playing of the video content.

50. A method according to claim 38, wherein each event comprises at least one of an HTML script, image, multimedia content, text, and URL.

51. A method according to claim 38, wherein the video content comprises at least one of a video, soundtrack, and combination thereof.

52. A computer-readable storage medium holding code for performing the method according to claim 38.
